(19) United States
(12) Patent Application Publication
(10) Pub. No.: US 2021/0309178 A1
(43) Pub. Date: Oct. 7, 2021

(54) SIDE AIRBAG APPARATUS AND FOLDING METHOD THEREOF

(71) Applicant: HYUNDAI MOBIS CO., LTD., Seoul (KR)

(72) Inventor: Geon Woong MOON, Yongin-si (KR)

(73) Assignee: HYUNDAI MOBIS CO., LTD., Seoul (KR)

(21) Appl. No.: 17/221,150

(22) Filed: Apr. 2, 2021

(30) Foreign Application Priority Data
Apr. 6, 2020 (KR) 10-2020-0041549

(51) Int. Cl. B60R 21/237

(52) U.S. Cl. CPC B60R 21/237; B60R 2021/23146

(57) ABSTRACT

A side airbag apparatus may include: a housing coupled to a seat and having a cover to open/close an opening; a first cushion housed in the housing, unfolded and deployed to the side by gas supplied from an inflator so as to open the cover, and formed by folding an airbag sheet; and a second cushion connected to the first cushion, wound toward the seat and housed in the housing, unwound and deployed to the outside through the opening when the first cushion is deployed, and formed by winding the airbag sheet.

### CROSS-REFERENCE TO RELATED APPLICATION

This application claims priority from and the benefit of Korean Patent Application No. 10-2020-0041549, filed on Apr. 6, 2020, which is hereby incorporated by reference for all purposes as if set forth herein.

### BACKGROUND

### Field

Exemplary embodiments of the present disclosure relate to a side airbag apparatus and a folding method thereof, and more particularly, to a side airbag apparatus which can prevent damage to a side structure of a seat by a deployment force concentrated on the side structure, and a folding method thereof.

### Discussion of the Background

In general, a side airbag apparatus of a vehicle refers to an apparatus that can instantaneously inflate an airbag in case of a vehicle collision, and thus reduce an injury caused by an impact.

Such a conventional side airbag apparatus is embedded in a side portion of a seat on which a passenger is seated. When a side collision of the vehicle occurs, a cushion is deployed to the side of the seat and protects the passenger from an impact caused by the side collision.

However, when the cushion of the conventional side airbag apparatus is deployed, a lower portion of the cushion, to which an inflator is connected, could be early deployed to hit a side structure of the seat. Thus, the side structure (B pillar or the like) of the seat could be damaged by a deployment force concentrated thereon.

The related art of the present disclosure is disclosed in Korean Patent Application Laid-Open No. 10-2004-0074673 published on Aug. 25, 2004 and entitled “Side Airbag for Vehicle”.

### SUMMARY

Various embodiments are directed to a side airbag apparatus capable of preventing damage to a side structure of a seat by concentration of deployment force, because an airbag body is uniformly deployed to the side of the seat while a second cushion is unwound simultaneously with or after deployment of a first cushion.

In an embodiment, a side airbag apparatus may include: a housing coupled to a seat and having a cover to open/close an opening; a first cushion housed in the housing, unfolded and deployed to a side by gas supplied from an inflator so as to open the cover, and formed by folding an airbag sheet; and a second cushion connected to the first cushion, wound toward the seat and housed in the housing, unwound and deployed to an outside through the opening when the first cushion is deployed, and formed by winding the airbag sheet.

Each of the first and second cushions may have one or more first tuck-in parts formed at the top thereof and one or more second tuck-in parts formed at the bottom thereof.

The first cushion may be formed by folding the airbag sheet one or more times toward a front surface and a rear surface of the housing.

The first cushion may have an overlap part formed in a Z-shape.

The cover may have a tear line formed at the edge thereof, and the tear line may be torn to open the cover when the first cushion is deployed.

The second cushion is deployed to the side of the seat through the opening, while supported on the inner surface of the housing space when gas is supplied from the inflator.

The second cushion may have a rolled part formed by rolling the airbag sheet toward the inflator.

The gas supplied from the inflator may be transferred to the second cushion through the first cushion.

In an embodiment, a folding method of a side airbag apparatus may include: a tuck-in folding step of forming one or more first tuck-in parts by pushing an upper portion of an airbag sheet toward a bottom of the airbag sheet, and forming one or more second tuck-in parts by pushing a lower portion of the airbag sheet toward a top of the airbag sheet; a first folding step of forming a first folded part by folding the tuck-in folded airbag sheet toward an inflator; a second folding step of forming a second folded part by folding a primarily folded airbag sheet toward the inflator; a third folding step of forming a rolled part by rolling a secondarily folded airbag sheet toward the inflator; and a fourth folding step of forming an overlap part by folding an inflator-side portion of the airbag sheet.

In the tuck-in folding step, two first tuck-in parts and two second tuck-in parts may be formed.

In the first folding step, the first folded part may be formed by folding a front surface of the tuck-in folded airbag sheet.

In the second folding step, the second folded part may be formed by folding a front surface of the primarily folded airbag sheet.

In the third folding step, the rolled part may be formed by rolling a front surface of the secondarily folded airbag sheet.

In the fourth folding step, the overlap part may be formed by folding a portion of the airbag sheet, where the rolled part is not formed.

The overlap part may be formed in a Z-shape.

The rolled part may be disposed to overlap the overlap part.

The rolled part and the overlap part may have the same width.

In accordance with the embodiments of the present disclosure, the side airbag apparatus and the folding method thereof can prevent damage to a side structure of the seat by concentration of deployment force, because the airbag body is uniformly deployed to the side of the seat while the second cushion is unwound simultaneously with or after the deployment of the first cushion.

### BRIEF DESCRIPTION OF THE DRAWINGS

FIG. 1 is a perspective view illustrating that a side airbag apparatus in accordance with an embodiment of the present disclosure is installed in a seat.

FIG. 2 is a cross-sectional view taken along line A-A of FIG. 1.

FIG. 3 is a cross-sectional view illustrating a process of deploying first and second cushions of the side airbag apparatus in accordance with the embodiment of the present disclosure.

FIG. 4 is a cross-sectional view illustrating that the first and second cushions of the side airbag apparatus in accordance with the embodiment of the present disclosure are deployed.

FIG. 5 is a plan view illustrating a process of forming a first tuck-in part and a second tuck-in part of an airbag sheet in the side airbag apparatus in accordance with the embodiment of the present disclosure.

FIG. 6 is a cross-sectional view taken along line B-B of FIG. 5.

FIG. 7 is a plan view illustrating a process of forming a first folded part of the airbag sheet in the side airbag apparatus in accordance with the embodiment of the present disclosure.

FIG. 8 is a cross-sectional view taken along line C-C of FIG. 7.

FIG. 9 is a plan view illustrating a process of forming a second folded part of the airbag sheet in the side airbag apparatus in accordance with the embodiment of the present disclosure.

FIG. 10 is a cross-sectional view taken along line D-D of FIG. 9.

FIG. 11 is a plan view illustrating a process of forming a rolled part of the airbag sheet in the side airbag apparatus in accordance with the embodiment of the present disclosure.

FIG. 12 is a cross-sectional view taken along line E-E of FIG. 11.

FIG. 13 is a plan view illustrating a process of forming an overlap part of the airbag sheet in the side airbag apparatus in accordance with the embodiment of the present disclosure.

FIG. 14 is a cross-sectional view taken along line F-F of FIG. 13.

FIG. 15 is a plan view illustrating the first cushion 210 and the second cushion 260 in the side airbag apparatus in accordance with the embodiment of the present disclosure.

FIG. 16 is a cross-sectional view taken along line G-G of FIG. 15.

### DETAILED DESCRIPTION OF THE ILLUSTRATED EMBODIMENTS

Hereafter, preferred embodiments of the present disclosure will be described in detail with reference to the accompanying drawings.

The advantages and features of the present disclosure and a method for accomplishing the advantages and features will be clearly understood with reference to the embodiments which will be described below in detail with the accompanying drawings.

However, the present disclosure is not limited to the following embodiments, and may be implemented in various manners. The present embodiments are provided only to make the present disclosure through and complete and fully convey the scope of the present disclosure to those skilled in the art to which the present disclosure pertains, and the present disclosure is defined only by the scope of the claims.

Moreover, in describing the present disclosure, detailed descriptions for a related publicly-known technology and the like will be ruled out in order not to unnecessarily obscure subject matters of the present disclosure.

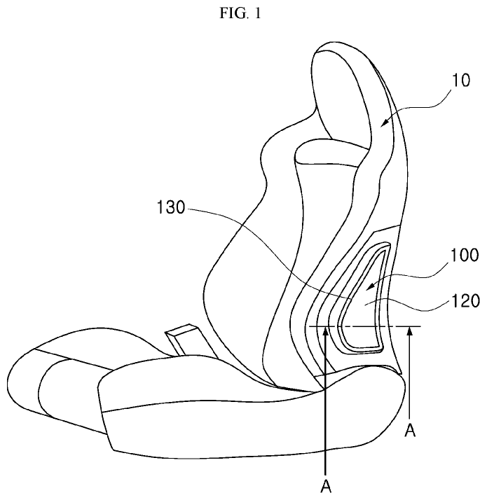

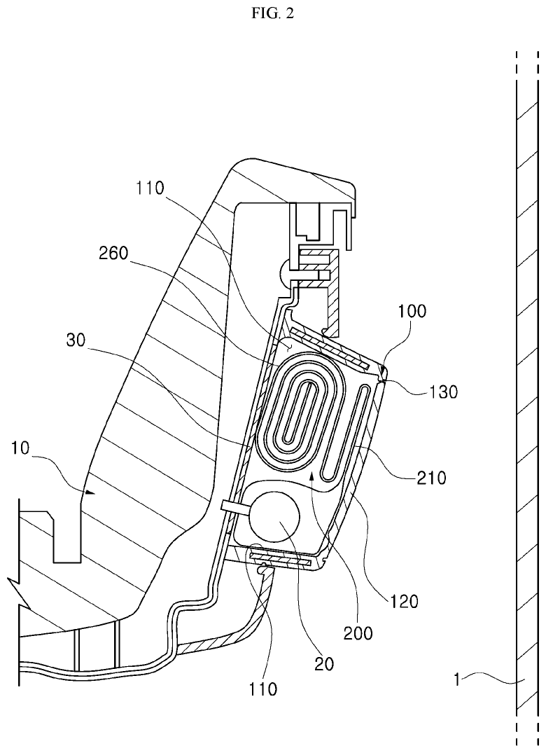

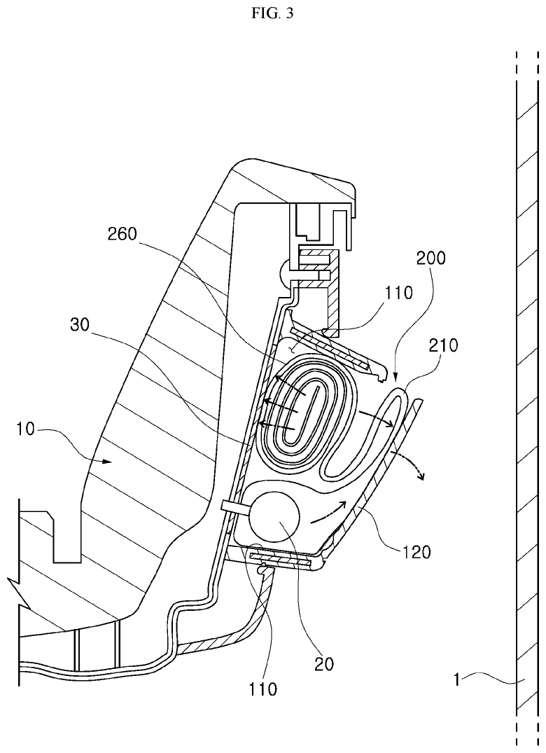

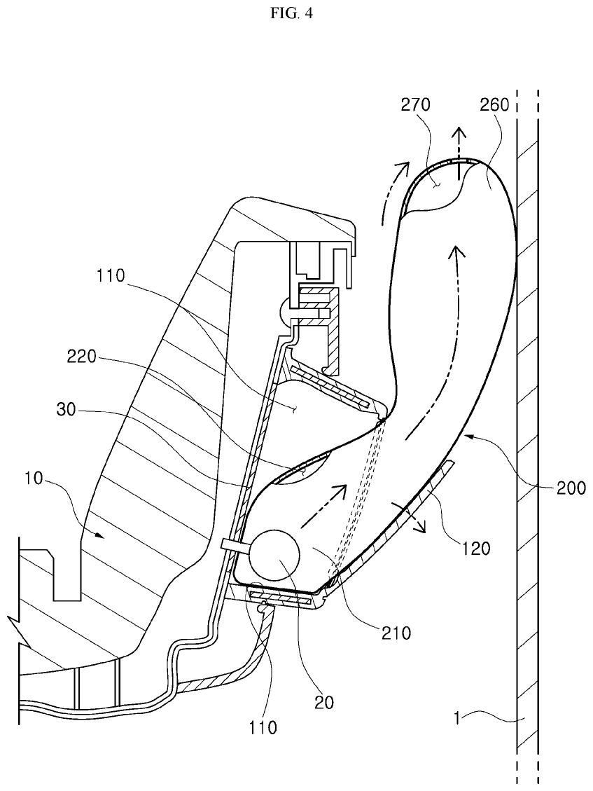

FIG. 1 is a perspective view illustrating that a side airbag apparatus in accordance with an embodiment of the present disclosure is installed in a seat, FIG. 2 is a cross-sectional view taken along line A-A of FIG. 1, FIG. 3 is a cross-sectional view illustrating a process of deploying first and second cushions of the side airbag apparatus in accordance with the embodiment of the present disclosure, and FIG. 4 is a cross-sectional view illustrating that the first and second cushions of the side airbag apparatus in accordance with the embodiment of the present disclosure are deployed.

Referring to FIGS. 1 to 4 and 10, the side airbag apparatus in accordance with the embodiment of the present disclosure includes a housing 100 and an airbag body 200. The airbag body 200 includes a first cushion 210 and a second cushion 260.

The housing 100 is coupled to a side portion of a seat 10, and has a housing space 110 formed therein. The housing 100 has a cover 120 provided on one side thereof, the cover 120 serving to close the housing space 110.

The housing 100 may be coupled to a separate bracket (not illustrated), and the bracket may be coupled to the seat 10 by a separate fastening member.

The housing 100 may be coupled to the back of the seat 10, and the cover 120 may be formed as one body with the housing 100.

As illustrated in FIG. 2, the airbag body 200, i.e. the first and second cushions 210 and 260 may be housed in the housing space 110 of the housing 100, while the volume thereof is reduced.

An inflator 20 for supplying gas to the first and second cushions 210 and 260 may be installed in the housing space 110.

The housing 100 may further have a seat bracket 30 installed on one side thereof, the seat bracket 30 serving to couple the first and second cushions 210 and 260 and the inflator 20, which are installed in the housing space 110.

The cover 120 has a tear line 130 formed on a portion connected to the housing 100. That is, the tear line 130 is formed at the edge of the cover 120. When the airbag body 200 is deployed, the cover 120 is separated from the housing 100 while the tear line 130 is torn. At this time, the tear line 130 may be formed in a U-shape, such that a portion of the cover 120 can be still connected to the housing 100.

When the first cushion 210 is deployed, the tear line 130 may be torn to open the cover 120.

As the tear line 130 is torn, the cover 120 is separated from the housing 100, and reclined backward to open an opening of the housing 100, which had been closed by the cover 120. The first and second cushions 210 and 260 may be deployed while protruding to the outside through the opening of the housing 100.

The first cushion 210 is folded in a Z-shape and housed in the housing space 110 of the housing 100, while the volume thereof is reduced. The second cushion 260 is wound and housed in the housing space 110 of the housing 100, while the volume thereof is reduced. The first cushion 210 has a first filling room 220 formed therein and filled with gas, and the inflator 20 for supplying gas to the first filling room 220 is connected to one side of the first cushion 210.

The first cushion 210 is folded and housed in the housing space 110. The first cushion 210 is folded a plurality of times and disposed in the housing space 110. When gas is supplied from the inflator 20, the first cushion 210 is unfolded and deployed to the side.

The first cushion 210 may be folded one or more times toward the front and rear, thereby forming a plurality of layers to overlap one another. Then, the first cushion 210 may be located toward the cover 120 of the housing space 110.

The inflator 20 may be installed at the rear of the housing space 110, and connected to one end of the first cushion 210. However, the installation position of the inflator 20 may be set to various positions as needed.

The first cushion 210 is unfolded to the side (right side based on FIG. 3) when gas is supplied from the inflator 20, and the gas supplied to the first filling room 220 of the first cushion 210 is transferred to a second filling room 270 of the second cushion 260.

The first cushion 210 may be deployed to the outside through the opening of the housing 100, as the cover 120 is opened when the gas is supplied from the inflator 20. The first cushion 210 may maintain the deployed state in the housing space 110.

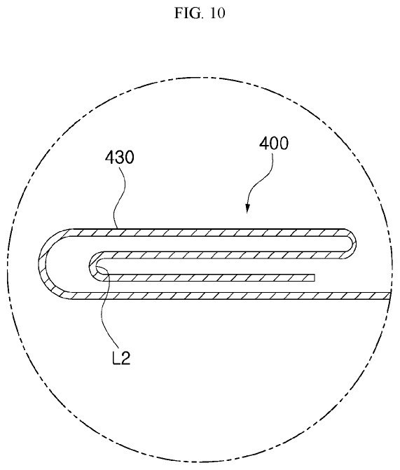

The first cushion 210 may be connected to the second cushion 260 as illustrated in FIG. 10.

The second cushion 260 is wound and housed in the housing space 110. As illustrated in FIG. 2, the second cushion 260 is connected to the first cushion 210 and wound and located toward the cover 120.

The second cushion 260 has the second filling room 270 formed therein and connected to the first filling room 220 of the first cushion 210 so as to be filled with gas.

The second cushion 260 may have a discharging hole for discharging the gas of the second filling room 270 to the outside so as to lower pressure when the second cushion 260 is deployed. The deployment pressure of the second cushion 260 may be adjusted by the discharging hole.

The second cushion 260 may be connected to the first cushion 210 and wound toward the rear of the housing 100. When the first cushion 210 is deployed, the second cushion 260 is unwound and deployed to the outside through the opening of the housing 100.

The second cushion 260 may be wound toward the front of the housing 100, and the winding direction of the second cushion 260 with respect to the housing 100 may be set to various directions as needed.

The second cushion 260 is inflated by the gas through the first cushion 210. The second cushion 260 applies an inflation force to the side, while supported on the inner surface of the housing space 110.

During this process, the second cushion 260 is deployed to the outside through the opening of the housing 100 by the inflation force of the first cushion 210. At this time, the second cushion 260 is deployed to the side of the seat 10 while unfolded in the opposite direction (front side) of the winding direction.

Since a side surface of the second cushion 260 is unfolded to the side (right side based on FIG. 3) on the same line and contacted with a side structure 1 (B pillar or the like) by a uniform deployment force, it is possible to prevent damage to the side structure 1 by the concentration of the deployment force.

As a result, simultaneously with or immediately after the deployment of the first cushion 210, the second cushion 260 is unwound and deployed to the side of the seat 10, which makes it possible to prevent damage to the side structure 1 which collides with the airbag body 200 as the deployment force of the airbag body 200 is concentrated.

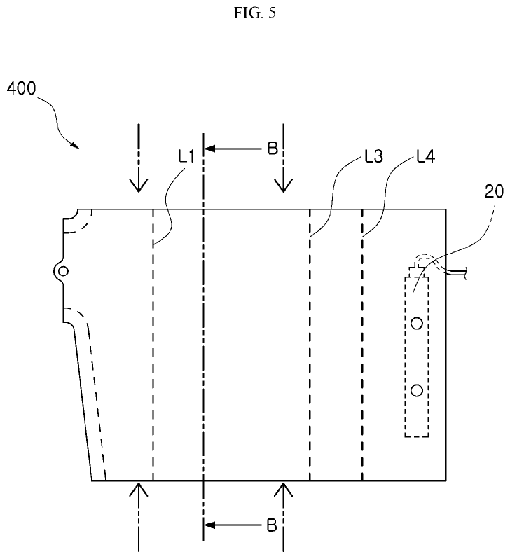

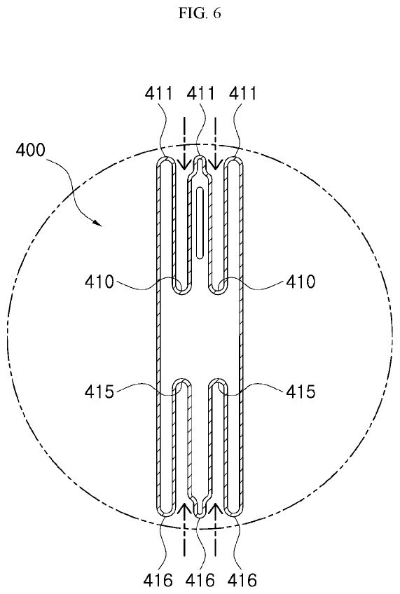

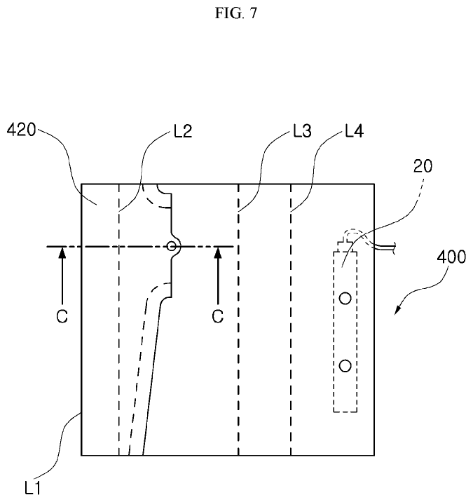

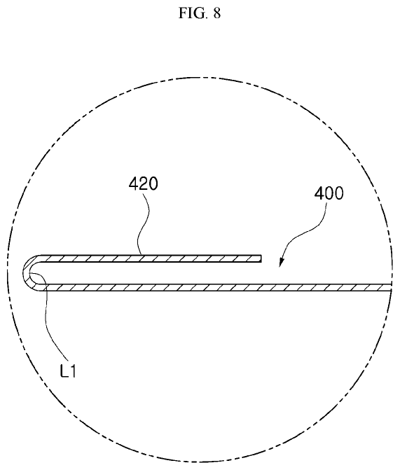

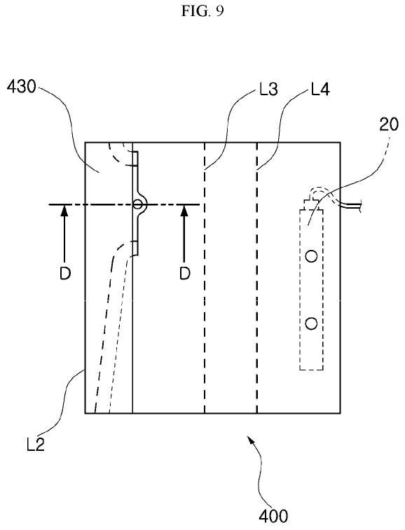

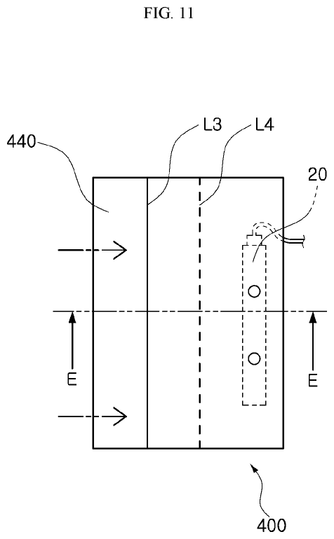

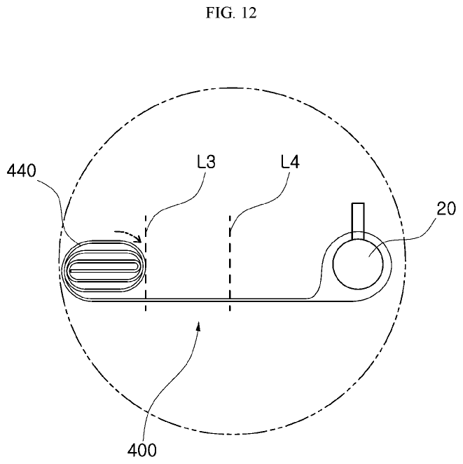

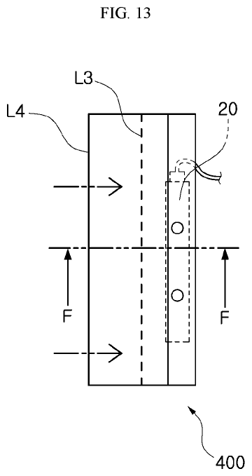

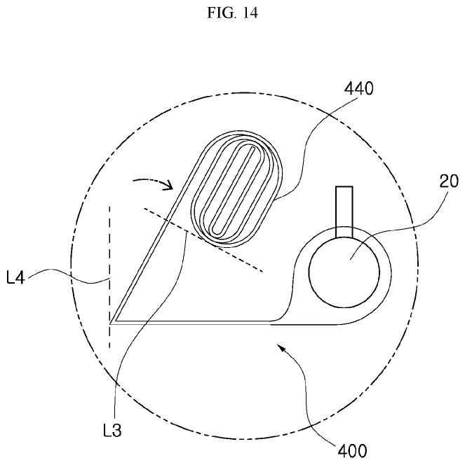

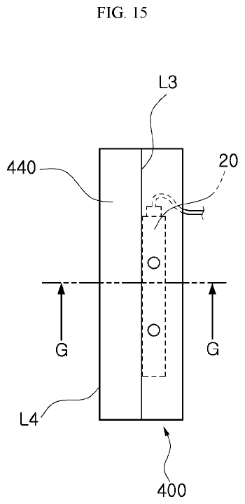

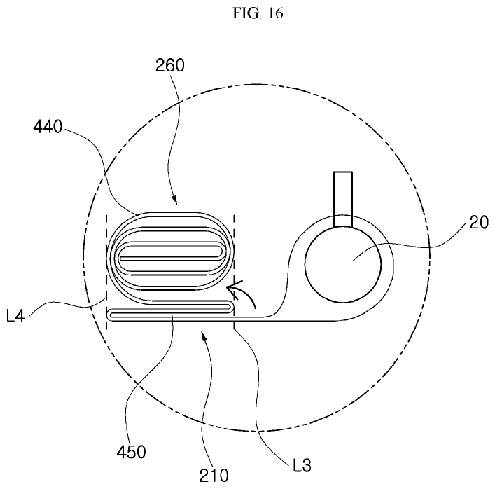

FIG. 5 is a plan view illustrating a process of forming a first tuck-in part and a second tuck-in part of an airbag sheet in the side airbag apparatus in accordance with the embodiment of the present disclosure, and FIG. 6 is a cross-sectional view taken along line B-B of FIG. 5. FIG. 7 is a plan view illustrating a process of forming a first folded part of the airbag sheet in the side airbag apparatus in accordance with the embodiment of the present disclosure, and FIG. 8 is a cross-sectional view taken along line C-C of FIG. 7. FIG. 9 is a plan view illustrating a process of forming a second folded part of the airbag sheet in the side airbag apparatus in accordance with the embodiment of the present disclosure, and FIG. 10 is a cross-sectional view taken along line D-D of FIG. 9. FIG. 11 is a plan view illustrating a process of forming a rolled part of the airbag sheet in the side airbag apparatus in accordance with the embodiment of the present disclosure, and FIG. 12 is a cross-sectional view taken along line E-E of FIG. 11. FIG. 13 is a plan view illustrating a process of forming an overlap part of the airbag sheet in the side airbag apparatus in accordance with the embodiment of the present disclosure, and FIG. 14 is a cross-sectional view taken along line F-F of FIG. 13. FIG. 15 is a plan view illustrating the first cushion 210 and the second cushion 260 in the side airbag apparatus in accordance with the embodiment of the present disclosure, and FIG. 16 is a cross-sectional view taken along line G-G of FIG. 15.

Referring to FIGS. 5 to 16, a process of folding an airbag sheet 400 to form the airbag body 200 with the first and second cushions 210 and 260 will be described as follows.

Referring to FIG. 5, the airbag sheet 400 is unfolded flat so that an inboard side thereof faces the front side. The inflator 20 may be provided on one side (the right side based on FIG. 5) of the airbag sheet 400.

A folding method of the side airbag apparatus includes a tuck-in folding step (see FIGS. 5 and 6), a first folding step (see FIGS. 7 and 8), a second folding step (see FIGS. 9 and 10), a third folding step (see FIGS. 11 and 12), and a fourth folding step (see FIGS. 13 to 16).

Referring to FIGS. 5 and 6, the tuck-in folding step includes forming one or more first tuck-in parts 410 by pushing the upper portion (the top based on FIG. 5) of the airbag sheet 400 toward the bottom of the airbag sheet 400, and forming one or more second tuck-in parts 415 by pushing the lower portion (the bottom based on FIG. 5) of the airbag sheet 400 toward the top of the airbag sheet 400.

Through the tuck-in folding step, the one or more first tuck-in parts 410 are formed at the upper portion of the airbag sheet 400, and first protrusions 411 are formed on both sides of the first tuck-in part 410, respectively. As the first tuck-in part 410 is formed toward the bottom of the airbag sheet 400, the first protrusion 411 is formed on the opposite side of the first tuck-in part 410 so as to face the top of the airbag sheet 400.

Through the tuck-in folding step, the one or more second tuck-in parts 415 are formed at the bottom of the airbag sheet 400, and second protrusions 416 are formed on both sides of the second tuck-in part 415, respectively. As the second tuck-in part 415 is formed toward the top of the airbag sheet 400, the second protrusion 416 is formed on the opposite side of the second tuck-in part 415 so as to face the bottom of the airbag sheet 400.

In the present embodiment, two first tuck-in parts 410 are formed. Thus, three first protrusions 411 are formed so that two first protrusions 411 are located on both sides of each first tuck-in part 410, respectively. Furthermore, two second tuck-in parts 415 are formed. Thus, three second protrusions 416 are formed so that two second protrusions 416 are located on both sides of each second tuck-in part 415, respectively. As the two first tuck-in parts 410 and the two second tuck-in parts 415 are formed, the top-to-bottom width of the airbag sheet 400 may be reduced.

Referring to FIGS. 7 and 8, the first folding step includes forming a first folded part 420 by folding the tuck-in folded airbag sheet 400 toward the inflator 20. For convenience of description, the illustration of the first tuck-in parts 410, the second tuck-in parts 415 and the like is omitted from FIG. 8.

As the front surface of the tuck-in folded airbag sheet 400, shown in FIG. 7, is folded toward the inflator 20 based on a first reference line L1, the first folded part 420 is formed in the airbag sheet 400.

Referring to FIGS. 9 and 10, the second folding step includes forming a second folded part 430 by folding the primarily folded airbag sheet 400 toward the inflator 20.

As the front surface of the primarily folded airbag sheet 400, shown in FIG. 9, is folded toward the inflator 20 based on a second reference line L2, the second folded part 430 is formed in the airbag sheet 400.

Referring to FIGS. 11 and 12, the third folding step includes forming a rolled part 440 by rolling the secondarily folded airbag sheet 400 toward the inflator 20.

As the front surface of the secondarily folded airbag sheet 400, shown in FIG. 11, is rolled up to a third reference line L3, the rolled part 440 is formed in the airbag sheet 400. Rolling indicates winding the airbag sheet 400 like a roll of paper.

Referring to FIGS. 13 and 14, the fourth folding step includes forming an overlap part 450 by folding the inflator-side portion of the airbag sheet 400. The overlap part 450 is formed by folding a portion of the airbag sheet 400, where the rolled part 440 is not formed.

As the front surface of the airbag sheet 400 is folded toward the inflator 20 based on a fourth reference line L4 and the rear surface of the airbag sheet 400 is then folded toward the opposite side of the inflator 20 based on the third reference line L3, the overlap part 450 is formed in the airbag sheet 400.

The third and fourth reference lines L3 and L4 may each have a length in the top-to-bottom direction of the first cushion 210. The third and fourth reference lines L3 and L4 may be spaced apart from each other in a widthwise direction thereof.

FIGS. 15 and 16 illustrate the airbag body 200 which is folded according to the folding method of the side airbag apparatus.

The airbag body 200 includes the second cushion 260 with the rolled part 440 and the first cushion 210 with the overlap part 450. The overlap part 450 may be formed in a Z-shape. Furthermore, the overlap part 450 may be formed in a zigzag shape.

The rolled part 440 may be disposed to overlap the overlap part 450. The rolled part 440 and the overlap part 450 may have the same width.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. An airbag system comprising:
a housing coupled to a seat and having an opening and including a cover configured to cover the opening;
a first cushion housed in the housing and comprising a folded portion of an airbag sheet, the first cushion configured to unfold and deploy when a gas is supplied from an inflator to the airbag sheet, wherein the unfolding and deploying of the first cushion cause the cover to be opened; and
a second cushion housed in the housing and comprising a wound portion of the airbag sheet connected to the folded portion of the airbag sheet, the second cushion configured to unwind and deploy through the opening when the gas is supplied to the airbag sheet.

2. The airbag system of claim 1, wherein each of the first and second cushions has one or more first tuck-in parts formed at a first side of the airbag sheet and one or more second tuck-in parts formed at a second side of the airbag sheet opposite to the first side.

3. The airbag system of claim 2, wherein the folded portion of the airbag sheet is folded one or more times toward a front surface or a rear surface of the housing.

4. The airbag system of claim 3, wherein the first cushion includes an overlap part having a Z-shape.

5. The airbag system of claim 4, wherein the cover has a tear line formed along an edge of the cover, the tear line configured to be torn when the first cushion is deployed.

6. The airbag system of claim 4, wherein:
the second cushion is positioned adjacent to an inner surface of the housing, and
the inner surface of the housing blocks the deploying of the second cushion towards the seat, which in turn directs the deploying of the second cushion in an opposite direction towards the opening of the housing.

7. The airbag system of claim 6, wherein the wound portion of the airbag sheet is wound toward the inflator.

8. The airbag system of claim 7, wherein the airbag sheet is configured to route the gas supplied from the inflator to the second cushion through the first cushion.

9. A method of manufacturing an airbag, comprising:
a first tuck-in folding step of pushing an upper portion of an airbag sheet toward a bottom of the airbag sheet to form a first tuck-in part;
a second tuck-in folding step of pushing a lower portion of the airbag sheet toward a top of the airbag sheet to form a second tuck-in part;
a first folding step of folding, upon completing the first and second tuck-in folding steps, the airbag sheet toward an inflator to form a first folded part;
a second folding step of folding, upon completing the first folding step, the airbag sheet toward the inflator to form a second folded part;
a third folding step of rolling, upon completing the second folding step, the airbag sheet toward the inflator to form a rolled part; and
a fourth folding step of folding, upon completing the third folding step, an inflator-side portion of the airbag sheet to form an overlap part.

10. The method of claim 9, wherein the first and second tuck-in folding steps causes two first tuck-in parts and two second tuck-in parts to be formed.

11. The method of claim 9, wherein the first folding step comprises folding a front surface of the airbag sheet to form the first folded part.

12. The method of claim 9, wherein the second folding step comprises folding a front surface of the airbag sheet to form the second folded part.

13. The method of claim 9, wherein the third folding step comprises rolling a front surface of the airbag sheet to form the rolled part.

14. The method of claim 9, wherein the fourth folding step comprises folding a portion of the airbag sheet to form the overlap part, wherein the folded portion of the airbag sheet and the rolled part are mutually exclusive.

15. The method of claim 14, wherein the overlap part is formed to have a Z-shape.

16. The method of claim 15, wherein the rolled part overlaps the overlap part.

17. The method of claim 15, wherein the rolled part and the overlap part have the same width.
